(19) United States
(12) Patent Application Publication
(10) Pub. No.: US 2019/0392400 A1
(43) Pub. Date: Dec. 26, 2019

(54) Social Meeting System

(71) Applicant: Michael Darius Garas, Irvine, CA (US)

(72) Inventor: Michael Darius Garas, Irvine, CA (US)

(21) Appl. No.: 16/443,713

(22) Filed: Jun. 17, 2019

Related U.S. Application Data
(60) Provisional application No. 62/689,043, filed on Jun. 22, 2018.

(51) Int. Cl. G06Q 10/10; G06F 16/22; G06Q 50/00

(52) U.S. Cl. CPC G06Q 10/1095; G06Q 50/01; G06Q 10/107; G06F 16/22

(57) ABSTRACT

A method for organizing meetings between users of mobile communication devices including receiving a time for a meeting from a first user computing device; receiving selections of other user computing devices to engage in a communication session with the first user computing device; communicating one or more messages to the selected other user computing devices to invite other users to meet with the first user; receiving one or more messages from at least one computing device of the selected other user computing devices identifying at least one of the other users is able to meet with the first user; and communicating one or more confirmation messages to the at least one computing device of the selected user computing devices to confirm a meeting between the first user and the at least one user associated with the at least one computing device.

### RELATED APPLICATIONS

This application claims priority to U.S. provisional patent application Ser. No. 62/689,043, filed Jun. 22, 2018, entitled “CIRCLE SOCIAL MEETING SYSTEM,” the disclosure of which is hereby incorporated by reference.

### BACKGROUND

Prior social media applications allow users to communicate with each other to make plans. There is a need for a social media application that makes the planning process more efficient by design and more effective through a notification system that first determines shared availability and mutual invitation acceptance. The claimed subject matter herein solves this problem.

### BRIEF DESCRIPTION OF DRAWINGS

FIG. 1 illustrates a communication and computer network system 100 that implements one or more embodiments of the social meeting system;

FIG. 2 illustrates a block diagram of operation of Circle Social Meeting system according to embodiments;

FIG. 3A illustrates a process implemented by a social meeting system and/or software according to some embodiments;

FIG. 3B illustrates a Circle social meeting system home page retrieved and displayed by the Circle social meeting system and/or software;

FIG. 3C illustrates an available now menu screen and is a transaction screen that provides a user with an opportunity to identify what the user would like to do;

FIG. 3D illustrates when a user's answer is that the user would like to invite friends to meet or connect (e.g., circle);

FIG. 3E illustrates a friend selection screen according to embodiments;

FIG. 3F illustrates an actual selection of friends a user would like to circle with;

In embodiments, the Circle social meeting system or software may return to a home screen such as illustrated in FIG. 3G;

FIG. 3H illustrates communications and/or responses from circle members (e.g., invitees or friends) and indicates whether the invitee or friend may be ready to meet (or circle) or if they may be available in the near future;

FIG. 4A illustrates selecting the “Available Later Today” option off of the Circle social meeting system menu;

FIG. 4B illustrates an input screen for “Available Later Today” which presents the user a “What would you like to do” and allows a user to enter an input;

FIG. 4C illustrates an “Available Later Today” input screen including a time input screen for a meeting or circle” as well as a button to invite friends;

FIG. 4D illustrates a list of contacts or friends that a user may select to invite for a meeting (or to “Circle” with);

FIG. 4E illustrates a friend list screen and one or more buttons where selections can be made to identify friends to invite for a meeting or circle with;

FIG. 4F illustrates that after the user communicates messages to friends and/or invitees, the Circle social meeting system or application retrieves and/or displays or servers the home screen of the Circle social meeting software;

FIG. 4G illustrates the messages or communications from the user's computing devices which may include whether or not the friend or invitee would like to meet along with a specified time;

FIG. 5A illustrates selecting the “Available This Week” option off of the Circle social meeting system menu;

FIG. 5B illustrates an input screen for “Available This Week” which presents the user with a list of the user's availability and/or days” and allows a user to enter or select an input;

FIG. 5C illustrates an “Available This Week—Daily” input screen including a time input screen for a user identifying what the user would like to do on the date that is selected.

FIG. 5D illustrates a time range input screen as button where a user can select to invite friends or contacts for a meeting or circle;

FIG. 5E shows a list of a user's friends with associated buttons and also provides the user with a button that allows a user to create a new group or edit an existing group that has their friends in;

FIG. 5F illustrates a friend list screen and one or more buttons where selections can be made to identify friends to invite for a meeting or circle with;

FIG. 5G illustrates that after the user communicates messages to friends and/or invitees, the Circle social meeting system or application retrieves and/or displays or servers the home screen of the Circle social meeting software

FIG. 5H illustrates the messages or communications displayed on the user's computing devices which may include whether or not the friend or invitee would like to meet along with a specified time;

FIG. 6A illustrates a contact or friend availability screen according to embodiments;

FIG. 6B illustrates a contact or friend availability screen for a day according to embodiments

FIG. 7 illustrates a computing device according to embodiments;

FIG. 8A illustrates a process implemented by a social meeting system and/or software according to some embodiments;

FIG. 8B illustrates input screens an Available Now Process according to some embodiments;

FIG. 8C illustrates input screens an Available Later Today process according to some embodiments; and

FIG. 8D illustrates input screens fir an Available This Week process according to some embodiments.

### DETAILED DESCRIPTION

The following detailed description and provides a better understanding of the features and advantages of the inventions described in the present disclosure in accordance with the embodiments disclosed herein. Although the detailed description includes many specific embodiments, these are provided by way of example only and should not be construed as limiting the scope of the inventions disclosed herein

Embodiments of an online dating system and service that uses a social network system and mobile communication device that incorporates a real-time display are described. In the following description, numerous specific details are introduced to provide a thorough understanding of, and enabling description for, embodiments of the system. One skilled in the relevant art, however, will recognize that these embodiments can be practiced without one or more of the specific details, or with other components, systems, and so on. In other instances, well-known structures or operations are not shown, or are not described in detail, to avoid obscuring aspects of the disclosed embodiments. In this application, the word “Circle” is utilized to identify a name provided for the social media system. This in no way limits the scope of claimed subject matter and instead is just a name of identification. Similarly, “Hangscope” may be utilize in other cases as a name for identification.

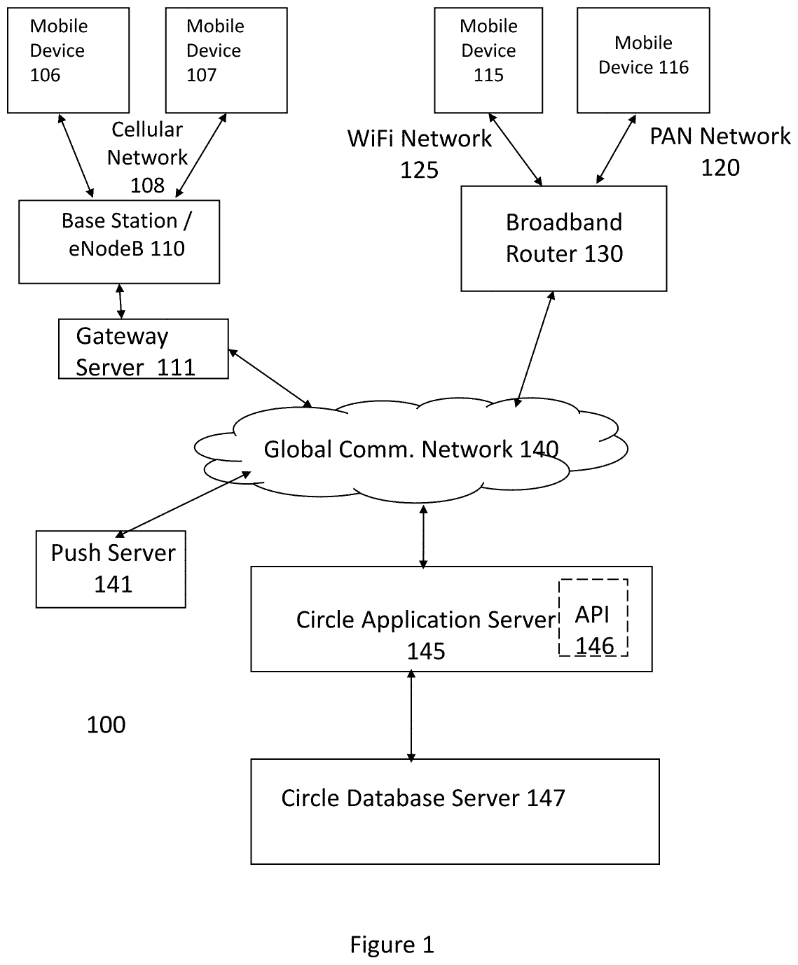

Embodiments are directed to a social meeting system that allows users of the social meeting system to schedule future meeting times according to embodiments. FIG. 1 illustrates a communication and computer network system 100 that implements one or more embodiments of the social meeting system. In embodiments, social meeting system 100, includes a plurality of mobile communication devices 106, 107, 115, and 116 are that may be coupled to a global communication network 140, such as the Internet. In embodiments, the mobile communication devices (or “mobile devices”) are each carried and operated by a user. In embodiments, the mobile communication devices may be smartphones, cellular phones, wearable computing devices, laptop computing devices and/or tablet computing devices. In embodiments, the mobile communications devices 106, 107, 115 and/or 116 may be able to communicate with one another using known communication methods such as wireless telephony, radio, satellite, cellular systems (e.g., GSM, CDMA, 3G, 4G, 5G and so on), or other similar systems, although not all of the mobile communication devices 106, 107, 115 and/or 116 may have these features.

In some embodiments, a server computer may be a Circle application server 145, which executes computer-readable instructions and runs a social meeting system process or software. In some embodiments, the computer-readable instructions may be executable by one or more processors on the application server. In embodiments, the social meeting system process executing on the Circle application server 145 may control various data objects relating to one or more social parameters or characteristics of the users of the mobile communication devices. In some embodiments, parameters, characteristics and/or data of the social meeting system users may be stored in a database server 147 (e.g., a Circle database server). In some embodiments, as is discussed below, users of the mobile communication devices may form one or more groups and/or a number of subgroups of people who desire to interact with one another on a social level by meeting with each other, participating in activities, sharing information or experiences, or other types of social or professional interaction. Because users of the mobile communication devices 106, 107, 115 and/or 116 are inherently transitory, there needs to be an online system for which these users to communicate. In some embodiments, parameters and/or characteristics of users may include a profile of each user, and the preferences of each user with respect to activities, people, privileges, and so on.

In some embodiments, each user who desires to interact with other users in the social meeting system using this data may utilize the social meeting system process. In some embodiments, one or more users may, through a subscription, or similar membership-type (free or fee-based) participation models, may register with the social meeting process by interfacing with the Circle application server 145 and providing preferences and other relevant information relating to the user. In some embodiments, entered or supplied parameters, characteristics or preference for each user or member may be stored in one or more databases servers 147 (e.g., Circle database servers), which are associated with the application servers 145. In some embodiments, parameters, characteristics and/or preferences may be stored and/or are organized in the database servers in, for example, user profiles, user provider parameters, characteristics or preferences.

In embodiments, the mobile devices 106, 107, 115 and/or 116 may communicate with the global communications network 140 and the application servers 145 and/or database servers 147 via a number of communications methods. In embodiments, as is illustrated by mobile communication devices 106 and 107, may communicate through a cellular network 108 to base stations or eNodeBs 110 and/or gateway servers 111 and then to the global communication network 140. In this illustrative embodiment, the mobile communication devices 106 and 107 are utilizing the cellular network to communicate with the application servers 145 and/or database servers 146.

In some embodiments, a mobile communication device (e.g., such as mobile device 115) may communicate with the global communication network 140 utilizing a WiFi (or wireless local area) network 125 and/or a broadband router 130. In embodiments, a mobile communication device (e.g., such as mobile device 116) may communicate with the global communication network 140 via a personal area network (e.g., Bluetooth network) 120 and/or one or more broadband routers 130.

In some embodiments, each of the mobile communication devices 106, 107, 115 and/or 116 may comprise one or more processors and/or one or more memory devices. In some embodiments, computer-readable instructions executable by one or more processors may operate social meeting system application software and may communicate with the social meeting system application server 145 and/or social meeting system database server 146. In some embodiments, the computer-readable instructions executable by one or more processors may facilitate establishment and management of user's account on the social meeting system application server 145 by providing a comprehensive interface to the social meeting system databases 147 and processes provided on the social meeting application server 145. In some embodiments, the mobile communications devices 106, 107, 115 and/or 116 may interface with the application servers 145 through a web server. In embodiments, the web server may be a server or process that stores data in the form of web pages and transmits these pages as Hypertext Markup Language (HTML) files over the global communication 140 to the mobile communications devices 106, 107, 115 and/or 116. In some embodiments, the one or more mobile devices typically run a web browser program to access the web pages served by the web server and any available content provider or supplemental server that may also be coupled to the network.

As shown in FIG. 1, the application server computers 145 may execute a server-side social meeting system process. In some embodiments, an application programming interface (API) 146 may allow users with mobile devices 115, 116, 106 and 107 to utilize browsers to communicate and/or login to the application server 145. In some embodiments, the application server computers 104 may comprise one or more processors and one or more memory devices. In embodiments, computer-readable instructions executable by the one or more processors may execute the social meeting system process. In some embodiments, the one or more mobile communications devices 106, 107, 115 and/or 116 may run or execute a client-side version of the social meeting system program, and/or they may access executable program components over the global communications network 140, such as through a web browser. In embodiments, data, preferences, characteristics and/or parameters for any of the users may be stored both locally (e.g., mobile communications devices 106, 107, 115 and/or 116). In some embodiments, the data, preferences, characteristics and/or parameters may be stored on a separate content provider computer of the one or more database servers 147 (e.g., there may be a designated server). In embodiments, although the one or more database servers 147 may be shown coupled to the one or more application servers 145, it should be noted that content data (e.g., data, preferences, characteristics and/or parameters) may be stored in one or more different physical locations. In embodiments, a social meeting system process may also include a database manager program that manages the different databases stored in the one or more database servers 147, which may be organized as separate databases, portions of a single database, or any other logical structure appropriate for storing the data, preferences, characteristics and/or parameters).

As illustrated in FIG. 1, the one or more database servers 147 stores user information, data, parameters and preferences. In embodiments, the information, data, parameters and preferences may relate to each user of mobile communications devices 106, 107, 115 and/or 116, and may include basic information, such as the user's name, identifier (nickname or “uid”), security check information (e.g., date of birth, mother's maiden name), and so on. In embodiments, for example, a user, when creating an account on the social meeting system, may provide an invite-code, which may have been communicated to the user through a messaging service, such as email and/or SMS messaging. In embodiments, a user may, during account creation also provide a phone number (which is validated by the social meeting system), their date of birth, an opt-in for push notifications, an opt-in for syncing of a user's mobile phone's contracts to the social meeting database server and/or an opt-in to allow the social meeting system and software to retrieve or capture user location as the user is using the social meeting system application software.

In embodiments, the one or more database servers 147 may also store the user's social and consumer preference information, such as what type of people the user is interested in meeting or dating, what days and/or times a user is able to meet with other social meeting system users, what types of food or events the user may prefer, and so on. In embodiments, the one or more database servers may also store graphic information related to each user, such as the user's picture, and any other associated images. These images can be displayed on the other user's mobile devices to provide a visual reference for each user. In embodiments, the one or more database servers may also request a user's full name and/or their gender.

The user provided database can also store other data objects, such as video clips, audio clips, hypertext links, documents, or other data provided by or associated with the user. In embodiments, location information may be stored for each user, such as location histories, frequently visited areas, and/or favorite places.

In embodiments, the one or more database servers 147 may further information and/or parameters relating to acquaintances, friends, family, or other contacts (hereinafter collectively referred to as “friends” or “contacts” or “your circle”), as well as other items of interest, such as places of interest or locations of events of interest. In embodiments, the social meeting system process may utilize the user profile and preference information to allow users to define networks of friends within the entire group of users. Using the messaging and calendar functions of the mobile communications device, the user can then send and receive messages on the device from these friends, or find places of interest or events in the area.

In embodiments, the social meeting system and/or software may collect and/or capture the following parameters, measurements and information and may store this information in one or more database servers 147. In embodiments, the parameters, measurements and/or information may be associated with a user's account. In embodiments, the parameters, measurements, and/or information may include specific activities that a user inputs into the social meeting application software (e.g., meet for coffee, go watch basketball game, etc.); a user's best friend list (which may be determined via invitation activity and/or user selection); how many times user invited other contacts or friends to utilize the application, invited other contacts to hangout or circle in real-life and how many times invited other contacts or users actually were matched and met with the user; a user's availability schedule on at least a daily and weekly basis; a user's friends or contact list; a user's location along with a time the user is at the location; and/or basic demographics information retrieved, for example, from a user's social medial accounts.

In embodiments, the social meeting system and application software may communicate and/or interact with a third-party server (e.g., Google Analytics server) to gather, capture and transfer user activity within the social meeting system application (e.g., the Circle application software). Parameters, measurements and information retrieved by the interface with, for example, Google Analytics server, and then stored in the one or more database servers 147 may include, but is not limited to addresses of pages viewed, any buttons tapped, typed or selected, frequency of usage of specific pages and/or software application, time and amount of usage of specific pages and/or software application and/or any additional demographic information.

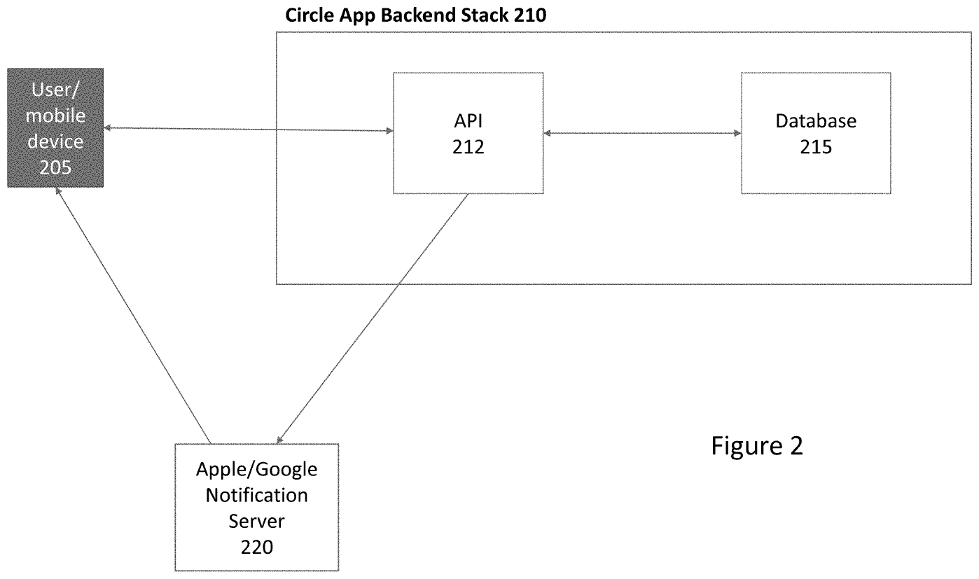

FIG. 2 illustrates a block diagram of operation of Circle Social Meeting system according to embodiments. In embodiments, the Circle Social Meeting system 200 comprises a user or mobile communication device 205, a Circle Backend Application Stack 210 and/or a Google or Apple Notification server 220. In embodiments, a Circle Social Meeting system 200 comprises a Circle application programming interface 212 and a Circle database server 215. In embodiments, a user or mobile communication device 205 includes a mobile software application running and executing thereon. In embodiments, the Circle mobile software application may be downloaded onto the user's mobile communication device 205 from Apple's App Store and/or Google's Play App store and may interface with software installed and executable on the Circle Backend Application Stack 210.

In embodiments, when a user mobile device communicates with an interacts with the Circle Social Meeting application, data, parameters and information may need to be transferred to the Circle database server 215 or be retrieved from the Circle database server 215. In embodiments, this transferring of data may occur while a user computing device 205 is logging in, signing up or creating an account or profile and/or storing relevant data, parameters and/or information. In some embodiments, a Circle API 212 may facilitate or assist in these transfers as well as controlling communications between user's mobile devices 205 and/or the backend applications stack 210. In embodiments, the Circle API 212 may also handle execution of computer-readable instructions by one or more processors to handle business logic of the Circle Social Meeting application. In some embodiments, as discussed above, the user input parameters, data and/or preferences and/or system generated parameters, data and/or preferences may be stored in the Circle database server 215.

In embodiments, the Circle Social Meeting system 200 may need to generate a notification to be sent to one or more user computing devices 205. In embodiments, any time a notification may need to be sent to a user computing device 205, a request must be made from the Circle API 212 in the Circle backend application stack to either Apple's or Google's notification server 220. In embodiments, the request may include specific information, parameters and/or data about what user mobile computing device should receive the notification. In some embodiments, the Apple or Google notification server 220 may need to communicate a verification to the Circle API 212 and may need to receive a verification from the user computing device 205. In embodiments, in response to receiving a verification from the user computing device 2105, the Apple or Google notification server 220 may push a notification to the user computing device 205 from either Apple's or Google's server

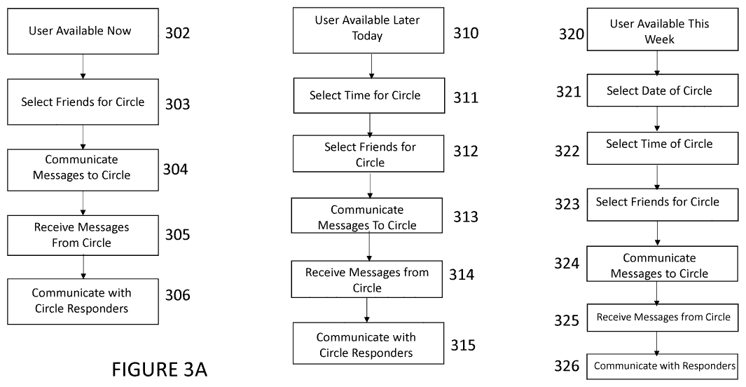

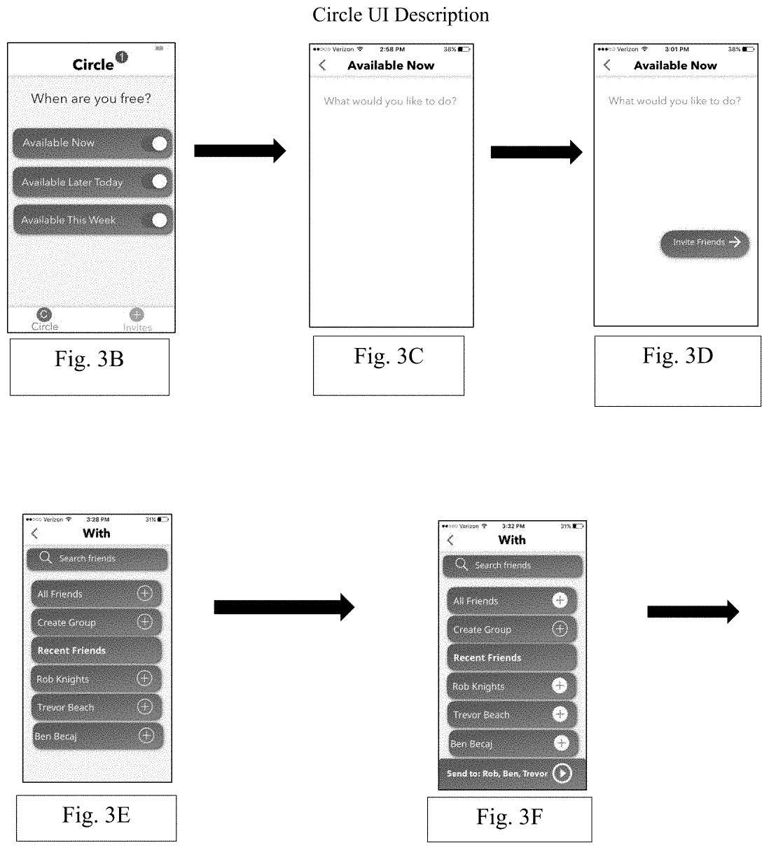

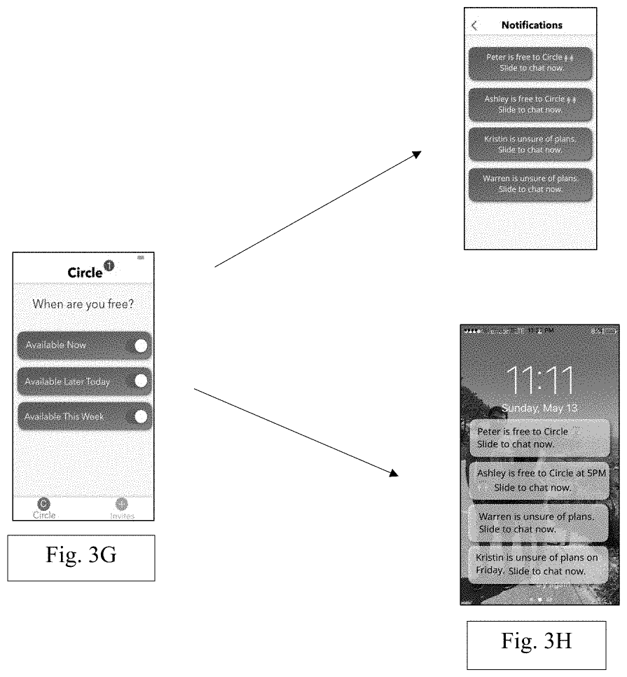

FIG. 3A illustrate a process of setting up meetings or circles with a number of contacts according to embodiments. A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

In embodiments, a user of the Circle social meeting system and/or software may select an availability timeframe. In embodiments, three options may be Available Now, Available Later Today and/or Available (Availability) This Week. In some embodiments, a user may select 302 that a user is available now. FIG. 3B illustrates a Circle social meeting system home page retrieved and displayed by the Circle social meeting system and/or software. In embodiments, a user may choose between “Available Now” “Available Later” and “Available This Week”. In some embodiments, the home page retrieved from the Circle social meeting database server and/or Circle social meeting application server. In some embodiments, the Circle home page may show notifications at a top of a served web page and/or a button for invites. FIG. 3C illustrates an available now menu screen and is a transaction screen that provides a user with an opportunity to identify what the user would like to do. FIG. 3D illustrates when a user's answer is that the user would like to invite friends to meet or connect (e.g., circle). In embodiments, the Circle social meeting system and software may generate and serve a screen including a button to allow a user to invite friends to meet or circle.

In some embodiments, a user may select friends 303 to circle or connect with via the Circle social meeting software or system. FIG. 3E illustrates a friend selection screen according to embodiments. In some embodiments, the Circle social meeting system and software may generate and serve a screen illustrating all of a user's friends and may provide the user that allows the user to create a group with their friends in a group and/or select a number of friends they would like to circle with.

FIG. 3F illustrates an actual selection of friends a user would like to circle with. In some embodiments, the Circle social meeting system and software may generate and/or serve a screen with buttons to allow a user to select a group of friends. For example, as illustrated in FIG. 3F, the users with an + symbol are selected as the users who will be receiving the invitation request message. In some embodiments, a message may also be displayed that indicates the message and/or invitation is being sent to the selected friends or contacts. In embodiments, a user's computing device may utilize a wireless transceiver to communicate and/or send 304 the invitation or message to the other user's computing device through the Circle social meeting system or software. In some embodiments, the Circle social meeting system may show or display only friends that have availability at the present time. In some embodiments, the messages may be sent via SMS text and/or other instant messaging technologies. In some embodiments, the Circle social meeting system or software may return to a home screen such as illustrated in FIG. 3G. In some embodiments, the invitees or friends (through the invitees or friends) computing devices may communicate back 305 with the user's computing device (through the Circle social meeting system or software). In some embodiments, these communications may be messages (e.g., SMS messages and/or notifications). FIG. 3H illustrates communications and/or responses from circle members (e.g., invitees or friends) and indicates whether the invitee or friend may be ready to meet (or circle) or if they may be available in the near future according to some embodiments. In some embodiments, the user or operator may then communicate 306 with any of the friends or invitees (or circle members) that have responded via SMS messaging or other messaging.

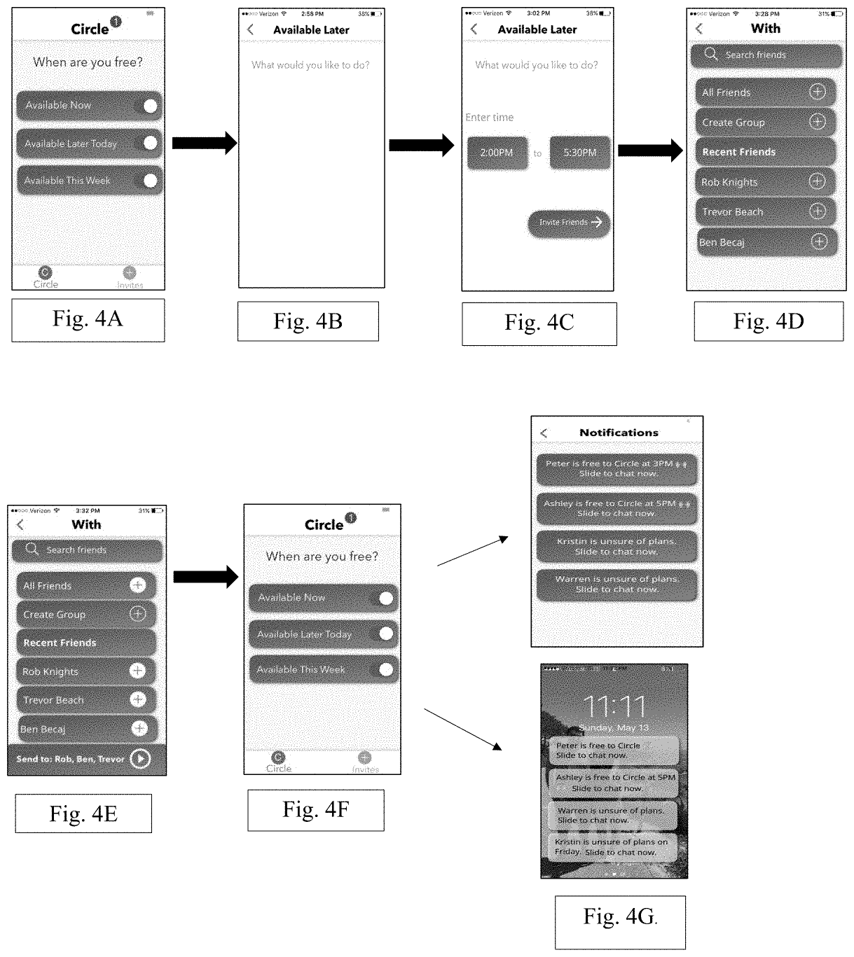

In some embodiments, a user may enter that he or she is Available Later Today 310 into the Circle social meeting system or software. In some embodiments, this may be done via typing in the information, a voice command, and/or a touch input. In some embodiments, the Circle social meeting system or software may retrieve and present or serve a web page asking for a time 311 for a meeting (or circle). FIG. 4A illustrates selecting the “Available Later Today” option off of the Circle social meeting system menu. In some embodiments, FIG. 4B illustrates an input screen for “Available Later Today” which presents the user a “What would you like to do” and allows a user to enter an input. In some embodiments, FIG. 4C illustrates an “Available Later Today” input screen including a time input screen for a meeting or circle” as well as a button to invite friends. In some embodiments, a Circle social meeting system and software may retrieve and then present or serve to a screen of the mobile communications device a time input screen 311 where the time can be input that the user would like to meet or circle up with other friends. In some embodiments, a Circle social meeting system and software may then retrieve and present or serve a friend list for selection 312 to a screen of the mobile communications device. FIG. 4D illustrates a list of contacts or friends that a user may select to invite for a meeting (or to “Circle” with). In some embodiments, FIG. 4D shows a list of a user's friends with associated buttons and also provides the user with a button that allows a user to create a new group or edit an existing group that has their friends in. FIG. 4E illustrates a friend list screen and one or more buttons where selections can be made to identify friends to invite for a meeting or circle with. FIG. 4E illustrates that a message and/or communication is going to be sent to the selected friends or contacts in the bottom of the menu or screen. In some embodiments, the user mobile computing device may communicate 313 an invitation or circle message to the one or more invitees, contacts or friends via one or more wireless transceivers. In some embodiments, the messages may be communicated via the Circle social meeting system or application to the invitee's or friends' mobile communications devices. In some embodiments, the user's computing device may receive messages or communications back 314 from the friends or invitees' computing devices indicating willingness that the friends or invitees are willing to meet. In embodiments, FIG. 4F illustrates that after the user communicates messages to friends and/or invitees, the Circle social meeting system or application retrieves and/or displays or servers the home screen of the Circle social meeting software. In some embodiments, FIG. 4G illustrates the messages or communications from the user's computing devices which may include whether or not the friend or invitee would like to meet along with a specified time. In some embodiments, the messages or communications may also indicate an invitee or friend is unsure of plans. FIG. 4G may show some notifications that a user may receive, for example, on a home screen. In some embodiments, the user and/or the friend or invitee may meet. In some embodiments, the user's mobile communication device may communicate messages 315 with the Circle responder's (e.g., the friends or invitees) device.

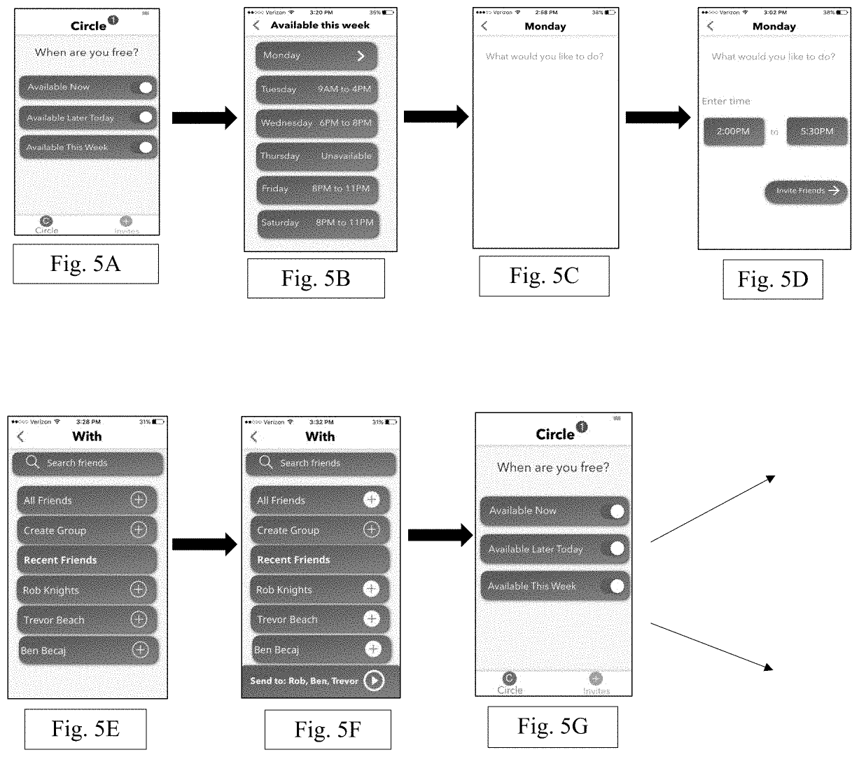

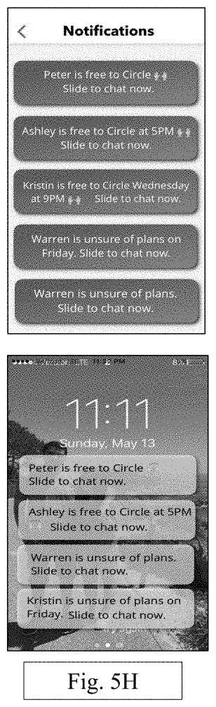

In some embodiments, a user may enter that he or she is Available This Week 320 into the Circle social meeting system or software. In some embodiments, this may be done via typing in the information, a voice command, and/or a touch input. In some embodiments, the Circle social meeting system or software may retrieve and present or serve a web page asking for a date 321 for a meeting (or circle). FIG. 5A illustrates selecting the “Available This Week” option off of the Circle social meeting system menu. In some embodiments, FIG. 5B illustrates an input screen for “Available This Week” which presents the user with a list of the user's availability and/or days” and allows a user to enter or select an input of which day they are available. In some embodiments, a Circle social meeting system or software may communicate with a Circle social meeting application server and/or database server, may retrieve a user's availability and may then present or serve a web page on a screen of a user's mobile computing device. In some embodiments, FIG. 5C illustrates an “Available This Week—Daily” input screen including a time input screen for a user identifying what the user would like to do on the date that is selected. FIG. 5D illustrates a time range input screen as button where a user can select to invite friends or contacts for a meeting or circle. In some embodiments, a Circle social meeting system and software may retrieve and then present or serve to a screen of the mobile communications device a time range input screen 322 where the time range may be input that the user would like to meet or circle up with other friends. In some embodiments, a Circle social meeting system and software may then retrieve and present or serve a friend list for selection 323 to a screen of the mobile communications device. FIG. 5E illustrates a list of contacts or friends that a user may select to invite for a meeting (or to “Circle” with). In embodiments, FIG. 5E shows a list of a user's friends with associated buttons and also provides the user with a button that allows a user to create a new group or edit an existing group that has their friends in. FIG. 5F illustrates a friend list screen and one or more buttons where selections can be made to identify friends to invite for a meeting or circle with. FIG. 5F also illustrates that a message and/or communication is going to be sent to the selected friends or contacts at the bottom of the screen. In some embodiments, the user mobile computing device may communicate 324 an invitation or circle message to the one or more invitees, contacts or friends via one or more wireless transceivers. In some embodiments, the messages may be communicated via the Circle social meeting system or application to the invitee's or friends' mobile communications devices. In some embodiments, the user's computing device may receive messages or communications back 325 from the friends or invitees' computing devices indicating willingness that the friends or invitees are willing to meet. In some embodiments, FIG. 5G illustrates that after the user communicates messages to friends and/or invitees, the Circle social meeting system or application retrieves and/or displays or servers the home screen of the Circle social meeting software. In embodiments, FIG. 5H illustrates the messages or communications displayed on the user's computing devices which may include whether or not the friend or invitee would like to meet along with a specified time. In some embodiments, the messages or communications may also indicate an invitee or friend is unsure of plans. FIG. 5H may show some notifications that a user may receive, for example, on a home screen. In some embodiments, the user and/or the friend or invitee may meet. In some embodiments, the user's mobile communication device may communicate messages 326 with the Circle responder's (e.g., the friends or invitees) device.

In some embodiments, with the Available Now, Available Later Today and Available This Week features, the Circle process (e.g., software application) may allow a user to send an unlimited number of invitations to a person who is using the application. However, if the user is not available, the Circle process (e.g., software application) may not send these invitations to the selected individual because the selected individual is not available. In some embodiments, the lack of communicating or sending the invitation removes a psychological fear of rejection from the user who is sending the invitation request and/or also remove a fear that the requesting user or individual is bothering the selected individual because the selected individual may only receive a notification when the other user is available to meet. In other words, in some embodiments, the Circle process (or software application) may only transmit requests to individuals who have indicated they are available at the time that is being requested by the initiating user.

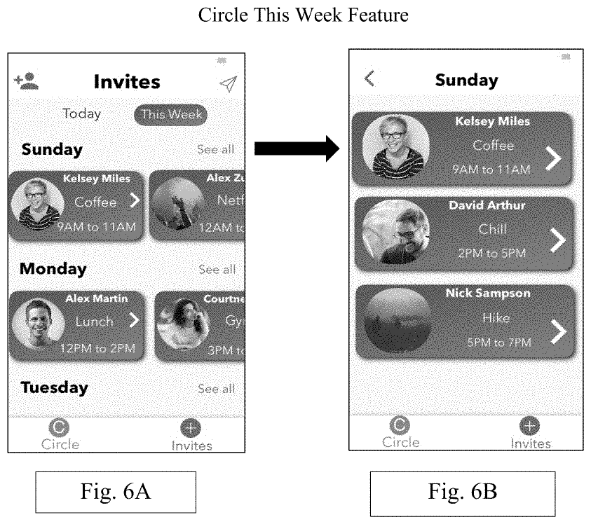

FIG. 6A illustrates a contact or friend availability screen according to some embodiments. In some embodiments, the contact or friend availability screen may show a date, a person and a time of availability for the other individual contact or friend within the day or within a week. FIG. 6A shows availability of friends or contacts for the week. In some embodiments, the contact or friend availability screen may display when (e.g., time and date) the friend or contact is available in the future and what even they would like to do. In some embodiments, a Circle social meeting system or application may retrieve a user's contact or friend list from an application server and/or a database server. In some embodiments, a Circle social meeting system or application server may then retrieve the friends' or contacts' availability from the application server and/or a database server. In some embodiments, a Circle social meeting system and/or software may then communicate the friends or contacts name or information, the time range the friends or contacts are available and/or the events and/or activities that the friends or contacts are available for to the user's computing device. The user's computing device may receive this information or parameters and may display, on a screen of the user's computing device, the friends name and/or picture, the day of availability, the time range of availability and/or the activity or event that the user would like to engage or participate in. In some embodiments, a user may then communicate with the contacts and/or friends and then communicate with the friends or contacts to engage in the activity.

FIG. 6B illustrates a contact or friend availability screen for a day according to some embodiments. In some embodiments, by selecting a “see all” indicator, a user can see availability of friends or contacts for that day, a time range for an activity and/or a description of the desired activity. In some embodiments, a Circle social meeting system or application may retrieve a user's contact or friend list from an application server and/or a database server. In some embodiments, a Circle social meeting system or application server may then retrieve the friends' or contacts' availability for that day from the application server and/or a database server. In some embodiments, a Circle social meeting system and/or software may then communicate the friends or contacts name or information, a friends or contacts image, a time range the friends or contacts are available and/or the events and/or activities for which the friends or contacts are available, to the user's computing device. The user's computing device may receive this information or parameters and may display, on a screen of the user's computing device, the friends name and/or picture, the time range of availability and/or the activity or event that the user would like to engage or participate in. In some embodiments, a user may then communicate with the contacts and/or friends and then communicate with the friends or contacts to engage in the activity.

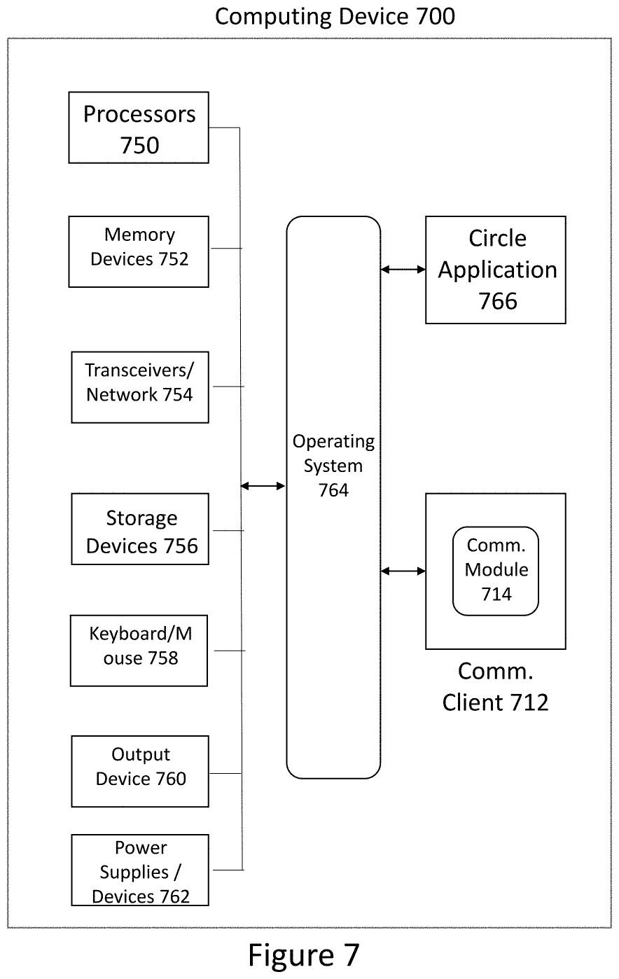

FIG. 7 illustrates a computing device or a mobile communication device according to some embodiments. As shown in the specific example of FIG. 7, mobile computing device 700 includes one or more processors 750, one or more memory devices 752, one or more transceiver or communication network interfaces 754, one or more storage devices 756, one or more input devices 758, one or more output devices 760, and one or more power sources 762. Mobile communications device or computing device 700 may also include one or more operating systems 764 that are executable by mobile communications device or computing device 700. Mobile communications device or computing device 700, in one example, may further include communication client 712 and one or more application software including but not limited to CIRCLE social meeting software 766 that are also executable by mobile communications device or computing device 700. Each of components 750, 752, 754, 756, 758, 760, 762, 764, 766, and 712 may be interconnected (physically, communicatively, or operatively) for inter-component communications.

In some embodiments, processors 750, in one example, are configured to at least implement functionality or process instructions for execution within client device 10. For example, one or more processors 750 may be capable of processing instructions stored in one or more memory devices 752 or instructions stored on one or more storage devices 756.

In some embodiments, one or more memory devices 752, in one example, is configured to store information within mobile communications device or computing device 700 during operation. One or more memory devices 752, in some examples, is described as a computer-readable storage medium. In some examples, one or more memory devices 752 may be used as a temporary memory, although one or more memory devices 752 may be used as long-term storage. In embodiments, one or more memory devices 752, in some examples, is described as a volatile memory, meaning that one or more memory devices 752 does not maintain stored contents when mobile communications device or computing device 700 is powered off. Examples of volatile memories include random access memories (RAM), dynamic random access memories (DRAM), static random access memories (SRAM), and other forms of volatile memories known in the art. In some examples, one or more memory device 752 is used to store program instructions for execution by one or more processors 750. In embodiments, one or more memory devices 752, in one example, is used by software or applications running on mobile communications device or computing device 700 (e.g., application 766 and/or one or more other applications 714) to temporarily store information during program execution.

In some embodiments, storage devices 756, in some examples, may also include one or more computer-readable storage media. In embodiments, storage devices 756 may be configured to store large amounts of information. In embodiments, storage devices 756 may further be configured for long-term storage of information. In some examples, storage devices 756 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Mobile communications device or computing device 700, in some examples, also includes one or more transceiver or communication network interfaces 754. Mobile communications device or computing device 700 in one example, utilizes transceiver or communication network interfaces 754 to communicate with external devices via one or more networks, such as one or more wireless networks. One or more transceiver or network interfaces 754 may be a network interface card, such as an Ethernet card, an optical transceiver, a radio frequency transceiver, or any other type of device that can send and receive information. Other examples of such network interfaces and/or transceivers may include Bluetooth, 3G, 4G, 5G and WiFi radios in mobile computing devices as well as USB. In some examples, mobile communications device or computing device 700 utilizes one or more communication and network interfaces 754 to wirelessly communicate with an external device such as a server device or server computing device, a mobile phone, or other networked computing devices.

Mobile communications device or computing device 700, in one example, also includes one or more input devices 758. Input devices 758, in some examples, are configured to receive input from a user through tactile, audio, or video input. Examples of input devices 758 may include a presence-sensitive screen, a mouse, a keyboard, a voice responsive system, video camera, microphone or any other type of device for detecting a command from a user. In some examples, a presence-sensitive screen includes a touch-sensitive screen. In embodiments, one or more output devices 760 may also be included in mobile communications device or computing device 700. In some embodiments, output device 760, in some examples, may be configured to provide output to a user using tactile, audio, or video output. Output devices 760, in one example, may include a presence-sensitive screen or a touch screen. In embodiments, output devices 760 may utilize a sound card, a video graphics adapter card, or any other type of device for converting a signal into an appropriate form understandable to humans or machines. In some embodiments, additional examples of output devices 760 may include a speaker, a cathode ray tube (CRT) monitor, a liquid crystal display (LCD), or any other type of device that can generate intelligible output to a user.

In some embodiments, mobile communications device or computing device 700, in some examples, may include one or more power sources or power supplies 762, which may be rechargeable and provide power to mobile communications device or computing device 700. In some embodiments, the one or more power sources or power supplies 762 may be one or more batteries. In embodiments, the one or more batteries may be made from nickel-cadmium, lithium-ion, or any other suitable material. In another example, in some embodiments, the one or more power sources or power supplies 762 may include a power supply connection that receives power from a power source external to mobile communications device or computing device 700. The one or more power sources or power supplies 762 may provide less power to communication client 712 when the virtual communication session is in an inactive, or ambient state, than when the virtual communication session is in an active state than when it is in an inactive state.

In some embodiments, one or more application software packages or modules 766 may provide mobile communications device or computing device 700 with additional functionality. In some embodiments, an application software package may include a Circle social meeting application software 766. In some embodiments, this additional functionality may include, for example, a social media application, a social meeting application like CIRCLE, web browsing, calendar, contacts, games, document processing, or any other functionality performed by a computing device such as mobile communications device or computing device 700. In embodiments, one or more software application packages 766 may cause at least one of output devices 760 to display some elements of a graphical user interface (GUI). In some embodiments, mobile communications device or computing device 700 may include one or more operating systems 764. Operating systems 764, in some examples, may control the operation of components of mobile communications device or computing device 700. For example, operating system 764, in one example, may facilitate the interaction of communication client 712 with processors 750, memory device 752, communication or network interfaces 754, storage devices 756, input devices 758, output devices 760, and power sources or power supplies 762. In some embodiments, communication client 712 may include communication module 714. In some embodiments, one or more software applications (including the Circle Social Meeting software application 766, communications client 712, and communication module 714 may each include at least one of computer-readable program instructions or data that are executable by one or more processors 750 of a mobile communications device or computing device 700. For example, in embodiments, communication module 714 may include computer-readable instructions executable by one or more processors 750 that cause communication client 712 to perform one or more of the operations and actions described in the present disclosure.

In some examples, in embodiments, at least one of application software packages 766, communication client 712, or communication module 714 may be a part of one or more operating systems 764 operating and being executed by one or more processors 750 of a mobile communications device or computing device 700. In some examples, in embodiments, communication client 712 may receive input from one or more input devices 758 of mobile communications device or computing device 700. In some embodiments, communication client 712 may, for example, receive at least one of audio or video information associated with a communication session from other computing devices participating in the communication session.

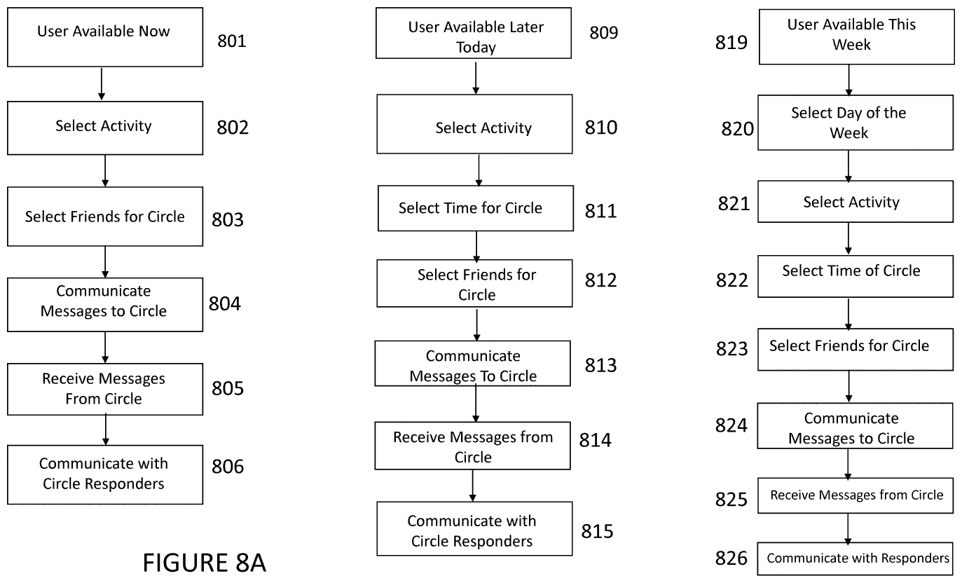

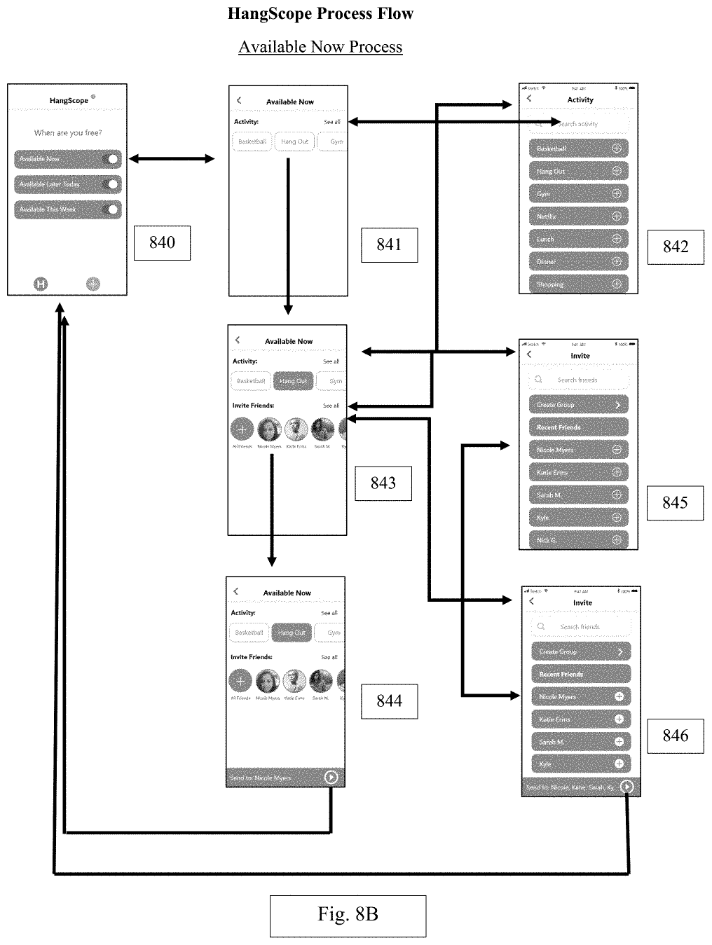

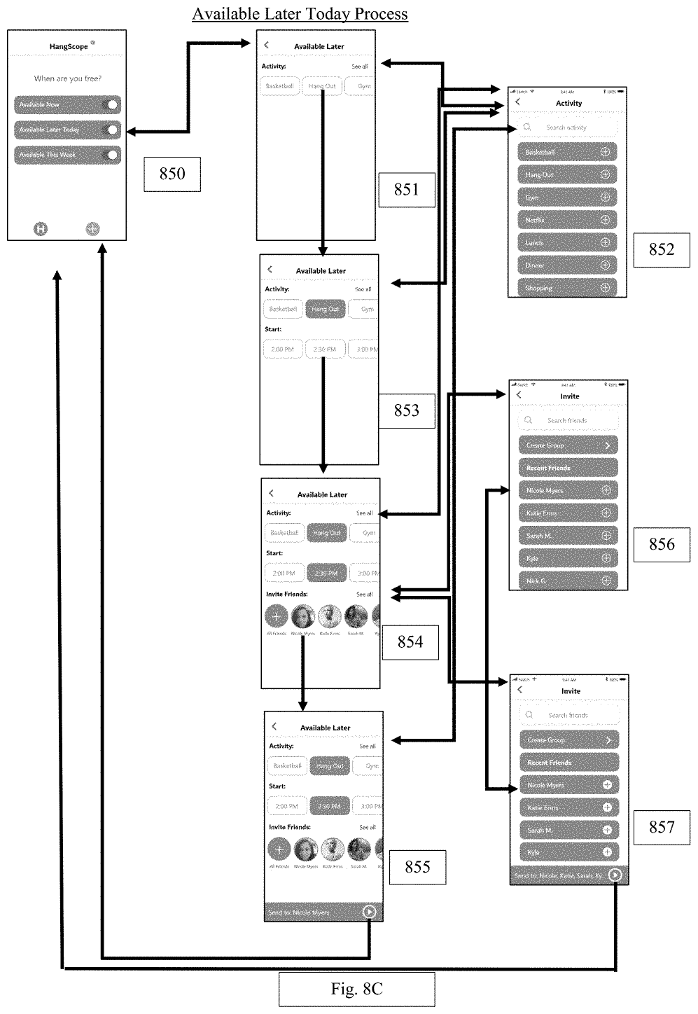

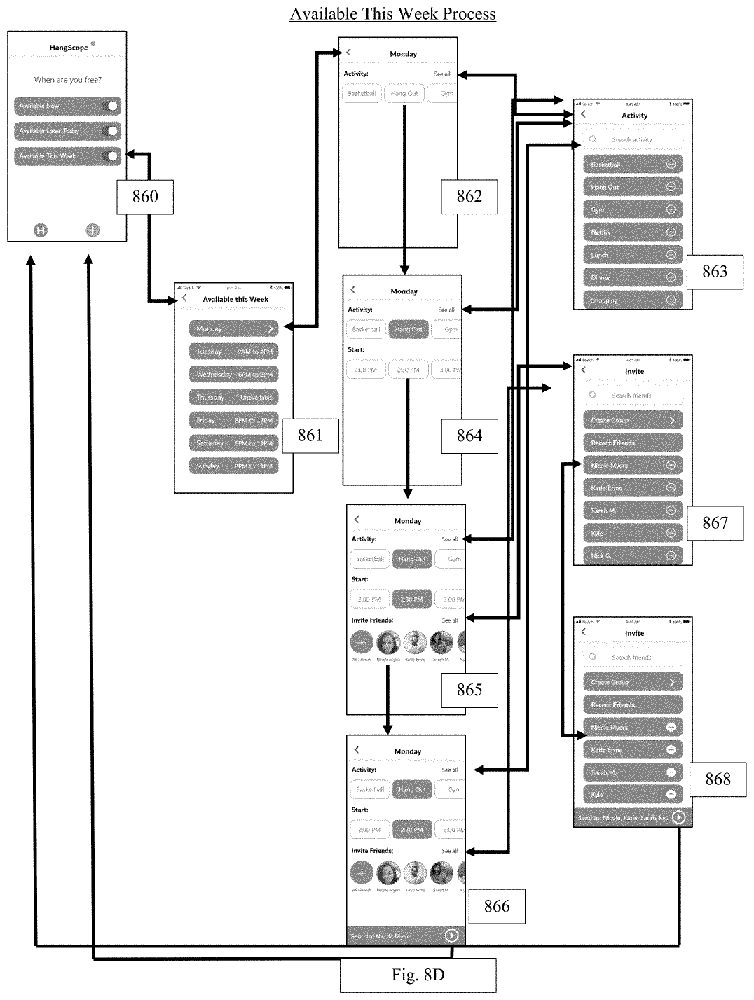

FIG. 8A illustrate a process of setting up meetings or circles with a number of contacts according to embodiments. A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

In embodiments, a user of the Circle social meeting system and/or software may select an availability timeframe. In embodiments, three options may be Available Now, Available Later Today and/or Available (Availability) This Week. In embodiments, a user may select 801 that a user is available now. For example, in some embodiments, a user may choose between “Available Now” “Available Later” and “Available This Week”. In some embodiments, the home page retrieved from the Circle social meeting database server and/or Circle social meeting application server. In some embodiments, the Circle home page may show notifications at a top of a served web page and/or a button for invites. In some embodiments, a transaction screen may provide a user with an opportunity to identify what the user would like to do. In some embodiments, a user may select an activity 802 that the user would like to participate in with friends. In some embodiments, the Circle social meeting system and software may generate and serve a screen including a button to allow a user to invite friends to meet or circle.

In embodiments, a user may select friends 803 to circle or connect with via the Circle social meeting software or system. In some embodiments, the Circle social meeting system and software may generate and serve a screen illustrating all of a user's friends and may provide the user that allows the user to create a group with their friends in a group and/or select a number of friends they would like to circle with. In some embodiments, the Circle social meeting system and software may generate and/or serve a screen with buttons to allow a user to select a group of friends. For example, the users with an + symbol are selected. In some embodiments, a message may also be displayed that indicates the message and/or invitation is being sent to the selected friends or contacts. In some embodiments, a user's computing device may utilize a wireless transceiver to communicate and/or send 804 the invitation or message to the other user's computing device through the Circle social meeting system or software. In embodiments, the messages may be sent via SMS text and/or other instant messaging technologies. In some embodiments, the messages may be include the selected activity the user may desire to participate in. In some embodiments, the Circle social meeting system or software may return to a home screen. In some embodiments, the invitees or friends (through the invitees or friends) computing devices may communicate back 805 with the user's computing device (through the Circle social meeting system or software) indicating that they would like to confirm to meet for a planned activity. In some embodiments, these communications may be messages (e.g., SMS messages and/or notifications). In some embodiments, communications and/or responses from circle members (e.g., invitees or friends) and indicates whether the invitee or friend may be ready to meet (or circle) or if they may be available in the near future. In some embodiments, the user or operator computing device may then communicate 806 with any of the friends or invitees (or circle members) (via the friends or invitees computing devices) that have responded via SMS messaging or other messaging.

In some embodiments, a user may enter that he or she is Available Later Today 809 into the Circle social meeting system or software. In some embodiments, this may be done via typing in the information, a voice command, and/or a touch input. In some embodiments, a user (via the Circle social meeting system or software) may select one or more activities 810 that the user would like to participate in with the other invitees or user. In some embodiments, the Circle social meeting system or software may retrieve and present or server a web page asking for activities or presenting activities to the user. In some embodiments, the Circle social meeting system or software may retrieve and present or serve a web page asking for a time 811 for a meeting (or circle). In some embodiments, an input screen for “Available Later Today” may present the user a “What would you like to do” and allows a user to enter an input. In some embodiments, an “Available Later Today” input screen may include a time input screen for a meeting or circle” as well as a button to invite friends. In some embodiments, a Circle social meeting system and software may retrieve and then present or serve to a screen of the mobile communications device a time input screen 811 where the time can be input that the user would like to meet or circle up with other friends. In some embodiments, a Circle social meeting system and software may then retrieve and present or serve a friend list for selection 812 to a screen of the mobile communications device. In some embodiments, a Circle social meeting system and software shows a list of a user's friends with associated buttons and also provides the user with a button that allows a user to create a new group or edit an existing group that has their friends in. In some embodiments, a friend list screen and one or more buttons where selections can be made to identify friends to invite for a meeting or circle with. In some embodiments, a message and/or communication may be sent to the selected friends or contacts. In embodiments, the user mobile computing device may communicate 813 an invitation or circle message to the one or more invitees, contacts or friends via one or more wireless transceivers. In some embodiments, the messages may be communicated via the Circle social meeting system or application to the invitee's or friends' mobile communications devices. In some embodiments, the messages may include the selected time and the selected activities that a user identified. In some embodiments, the user's computing device may receive messages or communications back 814 from the friends or invitees' computing devices indicating willingness that the friends or invitees are willing to meet (and these may be confirmation messages). In some embodiments, after the user communicates messages to friends and/or invitees, the Circle social meeting system or application may retrieve and/or display or serve the home screen of the Circle social meeting software. In some embodiments, the messages or communications from the user's computing devices which may include whether or not the friend or invitee would like to meet along with a specified time and/or the specified activity. In some embodiments, the messages or communications may also indicate an invitee or friend is unsure of plans. In some embodiments, the user and/or the friend or invitee may meet. In some embodiments, the user's mobile communication device may communicate messages 815 with the Circle responder's (e.g., the friends or invitees) device.

In some embodiments, a user may enter that he or she is Available This Week 819 into the Circle social meeting system or software. In some embodiments, this may be done via typing in the information, a voice command, and/or a touch input. In some embodiments, the Circle social meeting system or software may retrieve and present or serve a web page asking for an activity 820 that the user may like to participate in with friends or invitees. In some embodiments, the Circle social meeting system or software may retrieve and present or serve a web page asking for a date 821 for a meeting (or circle). In some embodiments, an input screen for “Available This Week” may presents a user with a list of the user's availability and/or days” and may allow a user to enter or select an input. In some embodiments, a Circle social meeting system or software may communicate with a Circle social meeting application server and/or database server, may retrieve a user's availability and may then present or serve a web page on a screen of a user's mobile computing device. In some embodiments, a Circle social meeting system and software may retrieve and then present or serve to a screen of the mobile communications device a time range input screen 822 where the time range may be input that the user would like to meet or circle up with other friends. In some embodiments, a Circle social meeting system and software may then retrieve and present or serve a friend list for selection 823 to a screen of the mobile communications device. In some embodiments, a Circle social meeting system and software may then retrieve and present or serve a list of contacts or friends that a user may select to invite for a meeting (or to “Circle” with). In some embodiments, the user mobile computing device may communicate 824 an invitation or circle message to the one or more invitees, contacts or friends via one or more wireless transceivers. In some embodiments, the messages may be communicated via the Circle social meeting system or application to the invitee's or friends' mobile communications devices. In some embodiments, the messages may include a selected or identified time, a selected or identified date and/or a selected or identified activity. In some embodiments, the user's computing device may receive messages or communications back 825 from the friends or invitees' computing devices indicating willingness that the friends or invitees are willing to meet on the specified date, at the specified time and/or for the specified activity. In some embodiments, after the user communicates messages to friends and/or invitees, the Circle social meeting system or application retrieves and/or displays or servers the home screen of the Circle social meeting software. In some embodiments, the messages or communications displayed on the user's computing devices may include whether or not the friend or invitee would like to meet along with a specified time. In some embodiments, the messages or communications may also indicate an invitee or friend is unsure of plans. In some embodiments, a user may receive notifications, for example, on a home screen. In some embodiments, the user and/or the friend or invitee may meet. In some embodiments, the user's mobile communication device may communicate messages 826 with the Circle responder's (e.g., the friends or invitees) device.

In some embodiments, with the Available Now, Available Later Today and Available This Week features, the Circle process (e.g., software application) may allow a user to send an unlimited number of invitations to a person who is using the application. However, if the user is not available, the Circle or Hangscope process (e.g., software application) may not send these invitations to the selected individual because the selected individual is not available. In some embodiments, the lack of communicating or sending the invitation removes a psychological fear of rejection from the user who is sending the invitation request and/or also remove a fear that the requesting user or individual is bothering the selected individual because the selected individual may only receive a notification when the other user is available to meet. In other words, in some embodiments, the Circle or Hangscope process (or software application) may only transmit requests to individuals who have indicated they are available at the time that is being requested by the initiating user.

Aspects of the present disclosure may improve social interaction because users may indicate when they are actually available to engage in a communication session. This feature makes a person more likely to invite another person because they don't have to worry that they will be bothering the other person at a time when they are not available. In the past, this fear of bothering the other phenomenon decreased the amount of invitations a person would send. However, the unique Circle or Hangscope process breaks down these social barriers and encourages a greater amount of social interaction. With a greater number of invitations occurring, it also will increase the chance that multiple users will have shared availability, which may increase the number of in-person meetings that occur.

FIG. 8B illustrates input screens an Available Now Process according to some embodiments. In some embodiments, in step 840, a user may select an Available Now button to initiate the Available Now process. In some embodiments, in step 841, a user may select an activity the user may like to engage in, may create their own custom activity and/or may change a view of the available activities that are available. In some embodiments, in step 842, a different view of available activities may be provided and a user may tap or select the activity they would like to engage in or create their own custom activity. In some embodiments, in step 843, a user may select or tap all friends or tap which specific friends to which the user would like to send an invitation. In some embodiments, in step 844, the user may select to communicate the invitation request to the friends. In some embodiments, the user may then return to the Available Now input screen. In some embodiments, in step 845, using a different view than in step 843, a user may select or tap all friends or which specific friends to which the user may send the invention. In some embodiments, in step 846, using a different view than 844, the user may tap to send the invitation request to the selected or identified friends. In some embodiments, the user may then return to the Available Now input screen. In some embodiments, the invitees or friends (through the invitees or friends) computing devices may communicate back with the user's computing device (through the social meeting system or software). In some embodiments, these communications may be messages (e.g., SMS messages and/or notifications). In some embodiments, the user or operator may then communicate with any of the friends or invitees (or circle members) that have responded via SMS messaging or other messaging that they are willing to meet now.

FIG. 8C illustrates input screens an Available Later Today process according to some embodiments. In some embodiments, in step 850, a user may tap or select an available later button to identify that the user may like to connect with friends at a later time. In some embodiments, in step 851, the user may select or tap the activity the user would like to do, tap or select to create a custom activity and/or change a view in the software of what activities can be selected. In some embodiments, in step 852 which is a different view than 851, the user can select or tap the activity they would like to engage in with others or may select or tap to create a custom activity. In some embodiments, in step 853, the user may select or tap a time at which the activity should start. In some embodiments, in step 854, the user may select which specific friends to invite to the selected activity at the selected time. In some embodiments, in step 855, the user may select to communicate or transmit the invitation to participate in the selected activity at the selected time to the selected friends. In some embodiments, in step 856, in a different view than 854, the user may select which specific friends to invite to the selected activity at the selected time. In some embodiments, in step 857, in a different view than 855, the user may select to communicate or transmit the invitation to participate in the selected activity at the selected time to the selected friends. In some embodiments, the user may then return to the screen where the user can select Available Now, Available Later or Available This Week. In some embodiments, the invitees or friends (through the invitees or friends) computing devices may communicate back with the user's computing device (through the social meeting system or software). In some embodiments, these communications may be messages (e.g., SMS messages and/or notifications). In some embodiments, the user or operator may then communicate with any of the friends or invitees (or circle members) that have responded via SMS messaging or other messaging who have indicated they are willing to meet at the later selected time.

FIG. 8D illustrates input screens fir an Available This Week process according to some embodiments. In some embodiments, in step 860, a user may select or tap the Available This Week option. In some embodiments, in step 861, the user may tap or select a specific day of the week that the user is available. In some embodiments, in step 862, the user may select or tap the activity that the user would like to engage in, create a customized activity or change a view of the available activities to be selected. In some embodiments, in step 863, which is a different view than 862, the user can tap or select the activity the user would like to do or create a customized activity in which the user would like to engage. In some embodiments, in step 864, a user may select or tap a time at which the user would like to engage in the selected activity. In some embodiments, in step 865, the user may select all or specific friends to which an invitation will be sent out to engage in the selected activity at the selected time. In some embodiments, in step 866, the user may select or tap to send or communicate the invitation to the selected friends to engage in the selected activity at the selected time. In some embodiments, the user may then return to the screen where the user selects Available Now, Available Later Today, and/or Available This Week. In some embodiments, in step 867, in a different view than 865, the user may select all or specific friends to which an invitation will be sent out to engage in the selected activity at the selected time. In some embodiments, in step 868, in a different view than 866, the user may select or tap to send or communicate the invitation to the selected friends to engage in the selected activity at the selected time. In some embodiments, the user may then return to the screen where the user selects Available Now, Available Later Today, and/or Available This Week. In some embodiments, the invitees or friends (through the invitees or friends) computing devices may communicate back with the user's computing device (through the social meeting system or software). In some embodiments, these communications may be messages (e.g., SMS messages and/or notifications). In some embodiments, the user or operator may then communicate with any of the friends or invitees (or circle members) that have responded via SMS messaging or other messaging that they are able to meet at a later day and/or time.

The above-identified process (in comparison to texting) significantly reduces screen engagement as well as how many inputs are required in order to perform actions. In other words, the keyboard or input screen is not utilized as much with the current process as compared to texting. When utilizing the above-identified process in comparison to texting (“Hey what's up are you free . . . ”), the user has to input less keystrokes which overtime reduces wear and tear on the mobile communication device or table screen, keypad and/or processing power. Utilizing the three scenarios described above (e.g., Available Now, Available Later Today and/or Available This week) in the most efficient manner, the following data and results were obtained. For the Available Now scenario: Texting: 3 taps, 29 taps for typing, 1 tap to send, 33 total taps as compared to present process (software application) of 5 total taps, 0 taps for typing. For the Available Later Today scenario: Texting: 3 taps, 37 taps for typing, 1 tap to send, 41 total taps as compared to present process (software application) of 6 total taps, 0 taps for typing. For the Available This Week scenario: Texting: 3 taps, 42 taps for typing, 1 tap to send, 46 total taps as compared to present process (software application) of 7 total taps, 0 taps for typing. This is a significant improvement over the current texting application and provides an increase in computer functionality when interfacing with users.

The invention as described in this document has been do so in an illustrative manner. As such it is understood that any terminology or examples used in this application are intended to help clarify the invention and provide additional description. In no way does the terminology or examples limit the invention. Many modifications and variations of the present invention are possible in light of the above teachings

In addition, the richness of the communicated reactions, e.g., video or audio representations of user expressions, may further improve the social interaction because such representations may convey more information with less user effort. The techniques described herein may be implemented in hardware, software, firmware, or any combination thereof. Various features described as modules, units or components may be implemented together in an integrated logic device or separately as discrete but interoperable logic devices or other hardware devices. In some cases, various features of electronic circuitry may be implemented as one or more integrated circuit devices, such as an integrated circuit chip or chipset.

If implemented in hardware, this disclosure may be directed to an apparatus such a processor or an integrated circuit device, such as an integrated circuit chip or chipset. Alternatively or additionally, if implemented in software or firmware, the techniques may be realized at least in part by a computer-readable data storage medium comprising instructions that, when executed, cause a processor to perform one or more of the methods described above. For example, the computer-readable data storage medium may store such instructions for execution by a processor.

A computer-readable medium may form part of a computer program product, which may include packaging materials. A computer-readable medium may comprise a computer data storage medium such as random access memory (RAM), read-only memory (ROM), non-volatile random access memory (NVRAM), electrically erasable programmable read-only memory (EEPROM), flash memory, magnetic or optical data storage media, and the like. In some examples, an article of manufacture may comprise one or more computer-readable storage media. In some examples, the computer-readable storage media may comprise non-transitory media. The term “non-transitory” may indicate that the storage medium is not embodied in a carrier wave or a propagated signal. In certain examples, a non-transitory storage medium may store data that can, over time, change (e.g., in RAM or cache).

The code or instructions may be software and/or firmware executed by processing circuitry including one or more processors, such as one or more digital signal processors (DSPs), general purpose microprocessors, application-specific integrated circuits (ASICs), field-programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, functionality described in this disclosure may be provided within software modules or hardware modules.

The above disclosure is sufficient to enable one of ordinary skill in the art to practice the invention, and provides the best mode of practicing the invention presently contemplated by the inventor. While there is provided herein a full and complete disclosure of the preferred configurations of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like. The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

1. A method for organizing meetings between users of mobile communication devices utilizing a computing device, the computing device including one or more physical memory devices, one or more processors, and computer-readable instructions stored in the one or more physical memory devices, the computer-readable instructions being executable by the one or more processors, the method comprising:
receiving a time for a meeting from a first user computing device;
receiving selections of two or more other user computing devices to engage in a communication session with the first user computing device;
communicating one or more messages to the selected two or more other user computing devices to invite other users to meet with the first user;
receiving one or more messages from at least one computing device of the selected two or more other user computing devices identifying at least one of the other users is able to meet with the first user; and
communicating one or more confirmation messages to the at least one computing device of the selected two or more user computing devices to confirm a meeting between the first user and the at least one user associated with the at least one computing device.

2. The method of claim 1, further comprising:
communicating calendar invite requests to the first user computing device and the at least one device of the selected two or more user computing devices, the calendar invite requests based at least in part on the time for the meeting.

3. The method of claim 1, the method further comprising:
selecting one or more activities to occur during the meeting.

4. The method of claim 3, the method further comprising:
communicating the selected one or more activities along with the one or more messages to the selected two or more other user computing devices to invite other users to participate in the one or more activities during the meet with the first user.

5. The method of claim 1, the method further comprising:
receiving a new activity that a first user can participate in with the other users; and
storing, in the one or more physical memory devices, the new activity in a database of activities.

6. A method for organizing meetings at a later time during a same day between users of mobile communication devices utilizing a computing device, the computing device including one or more physical memory devices, one or more processors, and computer-readable instructions stored in the one or more physical memory devices, the computer-readable instructions being executable by the one or more processors, the method comprising:
receiving a time later in the day for a meeting from a first user computing device;
receiving selections of two or more other user computing devices to engage in a meeting request communication session with the first user computing device;
communicating one or more messages to the selected two or more other user computing devices to invite other users to meet with the first user at the later time during the same day;
receiving one or more messages from at least one computing device of the selected two or more other user computing devices identifying at least one of the other users is able to meet with the first user at the later time during the same day; and
communicating one or more confirmation messages to the at least one computing device of the selected two or more user computing devices to confirm a meeting at the later time during the same day between the first user and the at least one user associated with the at least one computing device.

7. The method of claim 6, further comprising:
communicating calendar invite requests to the first user computing device and the at least one device of the selected two or more user computing devices, the calendar invite requests based at least in part on the later time during the same day for the meeting.

8. The method of claim 6, the method further comprising:
selecting one or more activities to occur during the meeting at the later time during the same day.

9. The method of claim 8, the method further comprising:
communicating the selected one or more activities along with the one or more messages to the selected two or more other user computing devices to invite other users to participate in the one or more activities during the meeting at the later time during the same day with the first user.

10. The method of claim 6, the method further comprising:
receiving a new activity that a first user can participate in with the other users; and
storing, in the one or more physical memory devices, the new activity in a database of activities.

11. A method for organizing meetings between users of mobile communication devices utilizing a computing device, the computing device including one or more physical memory devices, one or more processors, and computer-readable instructions stored in the one or more physical memory devices, the computer-readable instructions being executable by the one or more processors, the method comprising:
receiving a selection of a time and a day for a meeting from a first user computing device;
receiving selections of two or more other user computing devices to engage in a communication session with the first user computing device;
communicating one or more messages to the selected two or more other user computing devices to invite other users to meet with the first user at the selected time and the selected day;
receiving one or more messages from at least one computing device of the selected two or more other user computing devices identifying at least one of the other users is able to meet with the first user at the selected time and the selected day; and
communicating one or more confirmation messages to the at least one computing device of the selected two or more user computing devices to confirm a meeting at the selected time and the selected day between the first user and the at least one user associated with the at least one computing device.

12. The method of claim 11, further comprising:
communicating calendar invite requests to the first user computing device and the at least one computing device of the selected two or more user computing devices, the calendar invite requests based at least in part on the selected time and the selected date for the meeting.

13. The method of claim 11, the method further comprising:
selecting one or more activities to occur during the meeting at the selected time and the selected day.

14. The method of claim 13, the method further comprising:
communicating the selected one or more activities along with the one or more messages to the selected two or more other user computing devices to invite other users to participate in the one or more activities during the meeting with the first user during the selected time and the selected day.

15. The method of claim 11, the method further comprising:
receiving a new activity that a first user can participate in with the other users; and
storing, in the one or more physical memory devices, the new activity in a database of activities.

16. The method of claim 1, wherein performing the steps outlined in claim 1 includes less than 10 keystrokes or taps on a display screen of the computing device.

17. The method of claim 6, wherein performing the steps outlined in claim 6 includes less than 10 keystrokes or taps on a display screen of the computing device.

18. The method of claim 10, wherein performing the steps outlined in claim 10 includes less than 10 keystrokes or taps on a display screen of the computing device.
